(19) United States
(12) Patent Application Publication
(10) Pub. No.: US 2025/0369125 A1
(43) Pub. Date: Dec. 4, 2025

(54) SYSTEM AND METHODS FOR THE PRODUCTION OF HYDROGEN GAS

(71) Applicants: William H. SCHANK, JR., Howell, MI (US); Steven C. CARDONA, Naples, FL (US)

(72) Inventors: William H. SCHANK, JR., Howell, MI (US); Steven C. CARDONA, Naples, FL (US)

(21) Appl. No.: 19/085,466

(22) Filed: Mar. 20, 2025

Related U.S. Application Data
(63) Continuation-in-part of application No. 18/675,506, filed on May 28, 2024.

(51) Int. Cl. C25B 1/02; C02F 1/461; C02F 101/20; C02F 103/10; C25B 15/031; C25C 1/16

(52) U.S. Cl. CPC C25B 1/02; C02F 1/461; C25B 15/031; C25C 1/16; C02F 2101/20; C02F 2103/10; C02F 2209/06

(57) ABSTRACT

Methods and systems are disclosed for using industrial waste for the production of hydrogen gas. The method includes examining a pH level of the industrial waste, removing contaminate from the industrial waste, conditioning and concentrating the industrial waste to a proton-rich solution, and using the resulting proton-rich solution as the proton source in a hydrogenase catalyzed hydrogen production system.

### CROSS-REFERENCE TO RELATED APPLICATIONS

This application is a continuation-in-part of U.S. application Ser. No. 18/675,506, filed May 28, 2024 (now pending), which is continuation of U.S. application Ser. No. 16/620,654 filed Dec. 9, 2019, now U.S. Pat. No. 12,024,431, issued Jul. 2, 2024, which, in turn, claims priority from PCT/US18/37167 filed Jun. 12, 2018 (expired), which claims the benefit of provisional U.S. Application No. 62/518,771, filed Jun. 13, 2017, disclosures of which are hereby incorporated in their entirety by reference herein.

### TECHNICAL FIELD

This disclosure relates to acidic industrial waste and more particularly to systems and methods for using the acidic industrial waste for the production of hydrogen gas.

### BACKGROUND

The statements in this section merely provide background information related to the present disclosure and may not constitute prior art.

Fuel cell electric vehicles offer a carbon emission free alternative to internal combustion engine powered vehicles. They use oxygen from air and hydrogen gas to generate an electric current with water vapor and heat as the byproducts. Hydrogen combustion gives a heat quantity per unit mass three times or greater than petroleum oils, and when supplied to fuel cells, can be converted into electric and thermal energies with a high degree of efficiency. Hence, hydrogen is a desirable resource.

Many automotive manufacturers also want the production of hydrogen to be renewable such that the end-to-end delivery (production through consumption) is clean and without CO₂ emissions anywhere, “well to wheels.” Hydrogen is the “currency” of all fuels, so its green production has beneficial applicability to all fuels, hydrocarbons, and chemicals that contain it.

Besides the transportation industry, hydrogen gas may be utilized to produce key industrial chemicals, fertilizers, used in petroleum refining and hydro processing, metallurgy, energy production, electronics and semiconductor industry, food and beverage industry as well as pharmaceuticals and medical applications. A new use of hydrogen is in steel production to replace coal and coke and thus reducing carbon emissions.

Hydrogen, in its most common isotope, is the simplest of elements containing only one electron and one proton. Hydrogen is one of the most abundant elements on Earth, found in ubiquitous compounds such as water and hydrocarbons. However, hydrogen gas, which exists in diatomic form as H₂ under normal conditions, rarely exists in Earth's atmosphere or elsewhere on Earth.

The production of H₂ gas can be accomplished in several ways and from several precursors. However, with the exception of classic electrolysis using solar, wind, or hydroelectric power, all current commercial processes to produce H₂ gas result in carbon emissions into the atmosphere and consume more energy in the process than the resulting H₂ gas contains. The biggest obstacle to hydrogen production implementation is the high cost of producing “green” hydrogen, especially from the renewable sources.

Further, treatment and reduction of concentrations of pollutants in acidic industrial waste sources to environmentally acceptable levels have been a long standing environmental and economic problem. It is important to be able to treat such acidic industrial waste and remove metals, hazardous materials, and toxic substances, with minimal amounts of liquid or solid wastes remaining in a cost-effective manner. The ultimate solution to such environmental problems, recovery, recycling, and reuse of metals contained within waste sources has been inadequately addressed.

Hydrogenase enzymes catalyze the production of H₂ gas from protons and electrons. Although protons and electrons do not exist separate from the atoms they constitute, electron sources are readily available and electrons can easily be focused to a hydrogenase catalyzed reaction through many well-documented methods. For most compounds, it requires significant cost to separate protons from their various compounds or to generate constituent compounds.

Therefore, a need exists for an environmental and economic method and system for cleaning up industrial waste while producing hydrogen gas.

### SUMMARY

Method and system is disclosed for producing hydrogen gas using industrial waste catalyzed with hydrogenase.

Method and system is disclosed for using industrial waste for the production of hydrogen gas. The method includes examining a ph level of the industrial waste, identifying and removing contaminate from the industrial waste, conditioning the industrial waste, using the proton-rich solution in conjunction with an electron source in the presence of hydrogenase catalyst, removing hydrogen gas from the industrial waste, and storing the hydrogen gas.

Certain embodiments of the invention include applying the biological catalyst in vitro.

Certain embodiments of the invention include conditioning and normalizing the industrial waste to a predefined acidic ph level, e.g., 3-7.8.

This summary is provided merely to introduce certain concepts and not to identify key or essential features of the claimed subject matter.

In one or more embodiments, a hydrogen gas production system is disclosed. The system includes a first apparatus configured to produce a proton-rich solution having a concentration of hydrogen ions in a range of about 100 nM to 0.1 M from an acidic industrial waste; a source of electrons generating electrons; and a second apparatus configured to produce hydrogen gas by combining the electrons and the hydrogen ions. The system may also include an acidic industrial waste source for the acidic industrial waste, and wherein the acidic industrial waste includes acidic mine drainage (AMD). The acidic industrial waste may have a concentration of H⁺ exceeding 1 mol/L. The first apparatus may include Donnan-based separation. The source of electrons may include a power source. The second apparatus may include electrolysis.

In another embodiment, a hydrogen gas production system is disclosed. The system may include a source of an acidic industrial waste including one or more metals; a first apparatus configured to remove the one or more metals from the acidic industrial waste and to concentrate the acidic industrial waste to an acidic proton-rich solution; and a second apparatus configured to produce hydrogen gas by reacting hydrogen ions present in the acidic proton-rich solution with the one or more metals. The one or more metals may include Zn. The acidic industrial waste may include acidic mine drainage (AMD). The acidic proton-rich solution may have a concentration of H⁺ of about 100 nM to 0.1 M. The second apparatus may include a metal-acid reactor. The first apparatus may include an electrowinning apparatus. The one or more metals may include a source of electrons for the reaction of the proton-rich solution to produce the hydrogen gas. The second apparatus may include an acid amphoteric metal electrolysis reactor. The first and second apparatus may be in a fluid communication.

In yet another embodiment, a method of producing hydrogen gas is disclosed. The method may include providing a stream of an acidic industrial waste with a pH of about −3 to 7 and one or more contaminants; lowering a concentration of the contaminants in the acidic industrial waste; converting the acidic industrial waste into a proton-rich solution having H⁺ concentration of at least 100 nM; and generating hydrogen gas by combining electrons and the H⁺ in the proton-rich solution in a reactor. The method may also include extracting one or more metals from the one or more contaminants and using the extracted metals as a source of the electrons. The converting may include increasing pH of the acidic industrial waste. The generating may include a hydrogen evolution reaction (HER). The lowering may include removing one or more metals from the acidic industrial waste.

### BRIEF DESCRIPTION OF THE DRAWINGS

One or more embodiments will now be described, by way of example, with reference to the accompanying drawings, in which:

FIG. 1 schematically shows an exemplary hydrogen production system, in accordance with the present disclosure; and

FIG. 2 shows a process for using industrial waste for the production of hydrogen gas, in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment.

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed. Unless stated otherwise, the wt. % is based on the total weight of the substrate and the vol. % is based on the total volume of the substrate.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

As used herein, the term “substantially,” “generally,” or “about” means that the amount or value in question may be the specific value designated or some other value in its neighborhood.

Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . , 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps. The term “including” or “includes” may encompass the phrases “comprise,” “consist of,” or “essentially consist of.”

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Also, the description of a group or class of materials as suitable for a given purpose in connection with one or more embodiments implies that the group or class of materials can “comprise,” “consist of,” and/or “consist essentially of” any member or the entirety of that group or class of materials. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Hydrogen is a promising green energy alternative because it produces no direct emissions when used as a fuel, making it an ideal alternative to fossil fuels for reducing carbon footprints. When burned or used in fuel cells, hydrogen generates only water vapor, eliminating harmful greenhouse gas emissions. It is also highly versatile, capable of powering transportation, industries, and electricity generation, while complementing renewable energy sources by storing excess wind and solar power for later use. Unlike batteries, which degrade over time, hydrogen can be stored indefinitely and transported over long distances. If hydrogen production methods become more cost-effective, hydrogen would have the potential to play a crucial role in decarbonizing energy-intensive sectors and supporting a cleaner, more sustainable energy future.

However, hydrogen production is expensive primarily due to the energy-intensive processes required to extract it. The most common method, steam methane reforming (SMR), relies on natural gas, which not only incurs costs but also releases carbon dioxide, necessitating additional carbon capture technologies to make it environmentally friendly. Electrolysis, the process of splitting water into hydrogen and oxygen using electricity, is another method, but it remains costly because traditional electrolysis requires a significant amount of power. Since green hydrogen (produced via electrolysis using renewable energy) depends on clean electricity sources like solar and wind, its cost is directly tied to the price and availability of renewable energy, which remains high in many regions.

Thus, there is a need to lower the cost of hydrogen production.

In one or more embodiments disclosed herein, a system is disclosed. The system includes (A) a source of protons for hydrogen production, (B) a mechanism for producing hydrogen ions from the source of protons, (C) a source of electrons, and (D) a mechanism for producing hydrogen gas by combining the hydrogen ions and electrons.

The disclosed system leverages a previously unused source of protons, in the form of acids, which is currently considered industrial waste and requires regulatory management to prevent environmental contamination. This readily available source, commonly generated in industries such as mining, plating, and metal production, presents a burden due to its disposal requirements. By repurposing this waste stream, the herein-disclosed system significantly reduces the cost of acquiring hydrogen ions, addressing the high expenses typically associated with their procurement or extraction. Additionally, the system provides an effective means of mitigating industrial and mining waste, reducing storage hazards, and contributing to more sustainable waste management practices.

The source of protons for hydrogen production (A) may include acidic industrial waste. The term “acidic industrial waste” may include acidic mine drainage (AMD), acid rock drainage, acidic industrial waste stream, acidic waste from a mine run off and mine tailing run off, mining-influenced water, acidic waste from a mineral extraction process such as in surface hydraulic mining, well solution mining (ISL), minerals from ore processing, acid waste from iron, steel, and metal production processes such as plating, painting, and other finishing processes, metal refining waste stream, spent acid from chemical processing, any mine or industrial process liquid containing an acid, or their combination. The acidic industrial waste is common as a result of both metal mining of sulfide ores of cooper (Cu), zinc (Zn), lead (Pb), silver (Ag), and other metals and coal mining. The term “acidic industrial waste” encompasses man-made, human-induced, and natural processes resulting in production of an acidic drainage and acidic waste mentioned herein. The acidic industrial waste relates to an acidic liquid or an acidic aqueous solution with various contaminants disclosed herein.

Natural acidic waste streams from mines primarily result from AMD, a process where sulfide minerals, particularly pyrite (FeS₂), are exposed to air and water during and after mining activities. This exposure triggers a series of oxidation reactions that generate sulfuric acid (H₂SO₄), significantly lowering the pH of nearby water sources. As a result, the acidic runoff dissolves heavy metals such as iron (Fe), arsenic (As), lead (Pb), and cadmium (Cd), which can leach into groundwater and surface water, causing severe environmental contamination. AMD is a persistent liquid waste problem in both active and abandoned mines, particularly in coal, gold (Au), copper (Cu), and other metal mining operations. The acidic water can damage aquatic ecosystems by making the water uninhabitable for many species, harming plant life, and unusable for human consumption or use. Furthermore, once AMD begins, it can continue for decades or even centuries without intervention.

Mine tailings are solid or semi-solid waste left over after ore or mineral extraction, often stored in tailings dams or ponds. Mine tailings may include crushed rock, slurry, or sediments, unextracted minerals as well as chemical residues from processing such as cyanide, mercury, flotation reagents, ammonia, nitrate, etc. Mine tailings run off refers to water or liquid that drains or flows from mine tailings storage area, carrying the mine tailings, which may be acidic and similar to AMD in composition.

The acidic industrial waste may thus include water, dissolved metals including rare earth metals, toxic elements; AMD components such as sulfuric acid (H₂SO₄), various sulfates (SO₄²⁻); suspended solids and sediments such as fine rock particles, silicates, clays, metal hydroxides; chemical contaminants or residues from processing such as cyanide (CN⁻), flotation reagents (Xanthates, Frothers), residual acids and alkalis, nitrate, ammonia; radioactive elements (U, Th, Rn), or their combination.

The acidic industrial waste may have concentrations of metals within a range of up to several tens to several dozens to several hundreds mg/L, concentration of sulfates (SO₄²⁻) within a range of up to several hundred to several thousands of mg/L. The concentration of the metals and sulfates in the acidic industrial waste is an input concentration or first concentration.

For example, the concentration of iron (Fe) may range from about 10-2000 mg/L or higher, the concentration of copper (Cu) may range from about 0.01-50 mg/L or higher, the concentration of aluminum (Al) may range from about 1-500 mg/L, the concentration of nickel (Ni) may range from about 0.01-10 mg/L or higher, the concentration of lead (Pb) may range from about 0.005-5 mg/L, the concentration of manganese (Mn) may range from about 0.5-200 mg/L, the concentration of sulfate (SO₄²⁻) may range from about 100-10,000 mg/L. Some sites, such as the Iron Mountain Mine in California, US, Berkley Pit, Montana, US, or Rio Tinto, Spain, have much greater concentrations of metals such as Fe, Cu, and Zn, ranging in tens to hundreds of thousands mg/L.

Any acidic industrial waste which has a low pH (<7) may be a viable source of protons for the herein-disclosed system. The pH of the acidic industrial waste may be about or at most about 7, 6.5, 6, 5.5, 5, 4.5, 4, 3.5, 3, 2.5, 2, 1.5, 1, 0.5, 0, or negative pH such as a strong acid with hydrogen ion concentration exceeding 1 mole per liter. The negative pH may be at low as −0.5, −1, −1.5, −2, −2.5, −3, or −3.5. The H+concentration may be thus in tens, hundreds, or thousands moles per liter such as about 3.162 M/L for pH-0.5 to 3162 M/L for pH of −3.5.

The acidic industrial waste may be utilized to form a proton-rich solution.

The utilization may be realized via one or more mechanisms (B) for producing hydrogen ions from the source of protons (A). The mechanisms (B) may include one or more steps and one or more sub-mechanisms. The mechanisms may include one or more apparati and components disclosed herein. The mechanisms may be used separately on in a sequence.

Since the acidic industrial waste's composition, physical, and chemical properties are site-dependent, the acidic industrial waste adjustment and treatment may be tailored based on the initial examination of the site and the acidic industrial waste. The properties may have weather or seasonal variations and may be compensated for in the subsequent processing.

The acidic industrial waste may be located as a site, where it is produced naturally, as human-induced, or as man-made. The site and the acidic industrial waste's concentration, quantity, quality, chemical properties, physical properties, or their combination may be examined. The acidic industrial waste's analysis may include setting one or more goal characteristics of the acidic industrial waste resulting in a proton-rich solution with one or more predetermined characteristics or values. The one or more characteristics may include concentration of one or more metals, concentration of suspended solids, concentration of nanoparticles, pH, temperature, volume, etc.

As part of the adjustment of the acidic industrial waste, the acidic industrial waste may be first directed to enrich or sorb additional components. For example, an AMD may be purposefully provided to contact mine tailings to extract additional metals from the mine tailings. Such extraction may result in the acidic industrial waste increased concentration of certain metals, which may be extracted, and/or used, downstream via one or more mechanisms described herein.

The acidic industrial waste may be divided into streams, which may proceed through different treatments, resulting in different physical and/or chemical properties of the proton-rich solutions. The different streams may be then used in the same or different hydrogen gas production systems. In a non-limiting example, a first stream may be treated to have a different concentration of H⁺, metals, or both than a second stream. A first stream may have a different adjusted volume than the second stream.

The acidic industrial waste may be treated to remove debris, contaminates, organic waste, metals, or their combination. The treatment or adjustment may be conducted via screening, filtering, mechanical removal, chemical removal, etc. After examining the site, debris and contaminate may be removed from the acidic industrial waste at step 104. Debris can be removed using one or more known tools and techniques including screening, filtering, etc.

Known valuable elemental materials, and/or metals in general, may be extracted from the acidic industrial waste at this step. For example, precious metals, rare earth metals, Lanthanoids, transition metals, and other metals such as Au, Ag, Zn, Fe, Al, Mn, Pb, Ni, Co, Cr, Cd, Cu, Ni, Ti, Sc, Y, may be removed. Metals may be captured from water by immobilizing them in a sludge, coagulating, and separating the sludge from the water, de-watering the sludge and burning off the organic matter, and recovering selected metal by inorganic metal-winning process steps, as is known in the art.

The removal of metals from the acidic industrial waste may include chemical, physical, biological methods and apparati, or their combination. Non-limiting example techniques may include one or more of precipitation and pH adjustment such as neutralization, ion exchange resins, Donnan-based separation (membrane-based ion exchange process), magnetic separation such as magnetic liquid traps, cyclonic separation, implementation of biochar and bio absorbents, use of activated carbon, electrochemical recovery such as electrowinning, electrocoagulation, or electrofiltration, use of nano filters, selective membranes, or reverse osmosis, bioremediation such as bioleaching or biofilm reactors, or solvent extraction techniques such as use of organic solvents and chelating agents.

The removal of metals from the acidic industrial waste may have several benefits. First, the metals may be utilized for production in different industries. Alternatively or in addition, at least some of the removed metals may be used as a source of electrons or a source of additional hydrogen gas, as discussed herein. Second, the proton-rich solution free of metals is a better suited source of hydrogen ion than one containing metals. The presence of metals may create various issues in the hydrogen gas production cell due to its sensitivity. A predetermined concentration and composition of metals in the proton-rich solution as well as a predetermined pH may result in a more efficient hydrogen production system. The predetermined concentration of metals and metallic ions in the proton-rich solution may be about or at most about 0-20, 2-18, or 5-15 mg/L. The predetermined concentration is a second concentration.

After debris, organic waste, metals, or their combination are removed, the acidic industrial waste may be conditioned and/or concentrated at step 106. Conditioning may include one or more known techniques including membrane filtration, reverse osmosis, electrodialysis, nanofiltration, centrifuge, concentration of material, or their combination. The membrane filtration may utilize a semipermeable membrane or a membrane with target size specific pore size.

While conditioned, the sensors and probes may be programmed to concurrently and/or intermittently monitor conditions of the waste for reporting and analysis. In one embodiment, the acidic industrial waste is conditioned until reaching a predefined threshold of material concentration. In one or more embodiments, the acidic industrial waste is conditioned for a predefined time. In one or more embodiments, the acidic industrial waste is conditioned for a predefined number of operational cycles, e.g., one cycle of operational cycle of electro dialysis, one cycle of material concentration.

In one or more embodiments, the acidic industrial waste is conditioned to be a proton-rich solution. A proton-rich solution refers to a liquid solution that contains a high concentration of hydrogen ions (H⁺), which is highly acidic. The high concentration may be about or at most about 0.1×10⁻⁷ M (pH 7) to 0.1 M (pH 1), 1×10⁻⁶ (pH 6) to 1×10⁻² (pH 2), or 1×10⁻⁵ (pH 5) to 1×10⁴ (pH 4). The H⁺ concentration in the proton-rich solution may be about 100 nM to 0.1 M, 1 μM to 10 mM, or 10 μM to 100 μM. The H⁺ concentration in the proton-rich solution may be about or at least about 100, 200, 300, 400, 500, 600, 700, 800, 900, 1000 nM or 1 μM, 10, 100, 200, 300, 400, 500, 600, 700, 800, 900, 1000 μM or 1 mM, 10, 20, 30, 40, 50, 60, 70, 80, 90, or 100 mM or 0.1M. The H⁺ concentration in the proton-rich solution may be any number or range of numerals presented herein.

The conditioning to adjust pH may include lowering pH or increasing pH of the acidic industrial waste. For example, pH of the acidic industrial waste stream may be increased by addition of a strong or weak base or using a buffer system. The pH of the acidic industrial waste stream may be lowered by addition of a strong or weak acid.

The acidic industrial waste is thus converted into a proton-rich solution suitable as a source of hydrogen ion for hydrogen gas production. The protons, present in the acidic industrial waste, may be concentrated to increase hydrogen ion richness within the solution. The richness may be defined as the pH of the solution. In one or more embodiments, the acidic industrial waste may be adjusted to a predefined or predetermined pH level. The predetermined pH of the proton-rich solution may be about or at most about 7, 6.5, 6, 5.5, 5, 4.5, 4, 3.5, 3, 2.5, 2, 1.5, or 1.

In one or more embodiments, the pH level is defined as 6.5 or lower. In one or more embodiments, the pH level is defined as 6.5. In one or more embodiments, the pH level is concentrated to a range of between about 1-7, 2-7, 3-7, or 3-5. Common conditioning techniques have requirements in terms of cost, efficacy and thoroughness or remediation, which may be considered when selecting an acidic industrial waste for application of the disclosure herein. For example, pH of the acidic industrial waste may be raised, and the proton richness diluted such as in applications utilizing a biocatalyst. For example, in a hydrogenase system, pH should be higher than about 4 to support hydrogenase activity and ensuring the biocatalyst does not get damaged. The pH may be also adjusted by addition of a concentrated acid to stabilize the acidic industrial waste or the proton-rich solution as a required level.

After conditioning and concentrating the acidic industrial waste, the resulting proton-rich solution is ready for transport at step 108. Transport may be executed via a piping system or transport may be executed from the site via vehicles or by rail. The system described herein may be thus partially present at the acidic industrial waste site and partially away from the site.

Alternatively, the system described herein may be implemented at the acidic industrial waste site. This may be practicable especially if the acidic industrial waste contains metals which may be later utilized as source of electrons for the hydrogen gas production. In a non-limiting example, the acidic industrial waste may include zinc (Zn) which may be removed from the acidic industrial waste. The removed Zn may be later used in a metal-acid reactor to generate hydrogen gas once combined with the proton-rich solution in a chemical hydrogen generation. Zn loses electrons (oxidation) and dissolves into a solution as Zn²⁺ ions. The hydrogen ions from the proton-rich solution gain electrons (reduction) and form hydrogen gas. No external power is required. Alternatively, naturally-occurring Zn or a recycled source Zn may be added from an external source.

Within the conditioned acidic industrial waste, H⁺ ions are available for reactions. Acidic compounds exist within the acidic industrial waste, by definition, and depending on their strength (i.e., pH), have an abundance of protons which can be utilized and combined with the supplied electrons to produce H² gas.

A source of electrons (C) serves as a supply of electrons for the reaction of hydrogen ions and electrons to form hydrogen gas. An electron source may be applied to the solution, which may be supplied by one or more power sources, e.g., a battery, conventional electrical outlet, DC power adapter, solar panels (+DC converter), wind turbines, biomass, bioenergy, geothermal power, hydroelectric power, nuclear power, fuel cells, electrolyzer, generators, piezoelectric generators, flywheels, etc.

A source of electrons may also include an electrolysis such as electrolysis of water by applying a small voltage to water using electrodes, generating electrons at the cathode. A source of electrons may include microbial electrochemical systems such as microbial fuel cells with bacteria which naturally donate electrons as they break down organic waste in wastewater. A source of electrons may also include utilization of the metals previously removed from the acidic industrial waste or other scrap metals. For example, metal and metal dissolution of Fe, Al, or Zn may spontaneously release electrons as they dissolve in an acidic environment. The source of electrons may thus include a metal or non-metal source of electrons. A source of electrons may also include metals such as Fe, Al, or Zn which originate from a different source than the acidic industrial waste or from a different acidic industrial waste site, source, or stream than the acidic industrial waste which is converted to the proton-rich solution.

A mechanism for hydrogen gas production from the hydrogen ions and electrons (D) may include one or more apparati, components, sub-mechanism, or their combination. The mechanism (D) may utilize any known hydrogen gas production technique and method including biological, electrochemical, thermochemical, and chemical processes.

The first mechanism/apparatus (B) and the second mechanism/apparatus (D) may be on-site or off-site of the acidic industrial waste origination. The first and second mechanisms/apparati may be connected, linked, in communication, in fluid communication, or physically separated from one another.

In one or more embodiments, the mechanism (D) may utilize both the proton-rich solution as a source of protons (H⁺) and also at least some of the metals removed from the acidic industrial waste as a source of electrons. The utilization of both the metals and the acidic liquid may result in lower cost, lower energy requirements, and greater use of the acidic industrial waste. Such mechanisms include metal-acid reactions or direct chemical hydrogen generation, acid amphoteric metal electrolysis or enhanced hydrogen generation, metal-acid steam reforming or thermochemical hydrogen production, or their combination.

The metal-acid reactions involve reactions between metals and acids, transferring electrons to H⁺ ions, reducing them to hydrogen gas, as is illustrated in reaction (1):

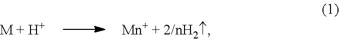

where

M is a metal such as Zn, Al, Fe, Mg, etc. and

H⁺ is a proton from the proton-rich solution.

The acid amphoteric metal electrolysis combines water electrolysis with metal-acid reactions to lower energy consumption. The water molecules are traditionally oxidized to provide protons (H⁺), and the metal acts as an electron donor to boost hydrogen evolution. The proton-rich solution may be used as the source of protons at the cathode (reduction) (3). The electrolysis speeds up due to metal-acid side reaction(s) (4a), (4b).

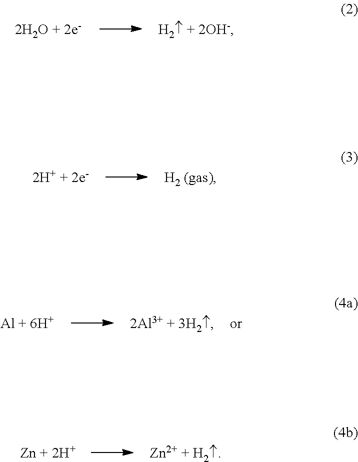

The metal-acid steam reforming utilizes metal-acid mixtures at elevated temperatures of about 200-800° C. to generate hydrogen gas. A non-limiting example reaction (45) is shown below:

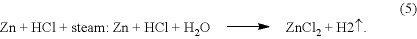

In a non-limiting example, the mechanism (D) includes a biological or electrochemical process such as a biological catalyst or a biocatalyst. In one embodiment, the biological catalyst is applied in vitro. In a non-limiting example, at step 110, the resulting proton-rich solution is used as the proton source in a hydrogenase catalyzed hydrogen production system. A biological catalyst in some embodiments may be hydrogenase. The source of hydrogenase may be bacteria, algae, methanogens, or their combination. Hydrogenases catalyse the reversible reaction (6):

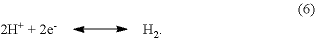

Other biocatalysts may be utilized, for example nitrogenase from nitrogen-fixing microbes. Nitrogenase may produce hydrogen as a byproduct while requiring ADP (7):

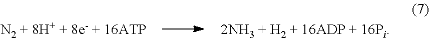

Alternative electrochemically-enhanced hydrogen gas production mechanisms may include microbes or electroactive bacteria which transfer electrons to protons to form hydrogen gas. Non-limiting example bacteria may include Geobacter sulfurreducens or Shewanella oneidensis.

Other electrochemical processes may include conventional electrolysis of an acid, hybrid electrolysis, or acid amphoteric water electrolysis. The electrolysis typically utilizes a cell having one or more compartments or containers, electrodes, an electrolyte solution, a power supply, and a gas collection system. The electrolysis may include an electrolyzer (PEM, alkaline). The electrolysis, such as the acid amphoteric water electrolysis, may utilize amphoteric metals such as Al and Zn which dissolve in acid, releasing hydrogen. The chemical reaction of the amphoteric metals with hydrogen ions thus supplements the electrolysis process, reducing the overall electrical energy needed to generate hydrogen. The amphoteric metals may be those previously removed from the acidic industrial waste or supplied from a different source.

The mechanism (D) may utilize metal-steam reactors for the thermochemical processes utilizing high temperatures.

The mechanism (D) may also include chemical reactions of one or more metals with acids such as sulfuric acid (H₂SO₄)+Zn→H₂ and ZnSO₄ or H₂SO₄+Mg→H₂ and MgSO₄. The mechanism may thus include a metal-acid reactor, pressurized reactor, autoclave reactor, stainless steel or glass-lined reaction chamber, controlled acid dosing system, electrolytic cell, rotary drum reactor, the like, or their combination. The one or more metals may be supplied from the metals originally extracted from the acidic industrial waste. Alternatively, the one or more metals may be provided from a different source.

After and/or while applying the biological catalyst or other mechanism (D), hydrogen gas may be extracted and stored at step 112. Extraction may be made by a hydrogen collection system, which may be a vacuum. Storage may be accomplished as a simple pressurized gas or liquid. Alternatively, the generated hydrogen gas may be stored in a hydrogen absorbing compound, e.g., a metal hydride. The hydrogen gas storage may be utilized via high-pressure hydrogen tanks as compressed gas storage, cryogenic hydrogen tanks as liquid hydrogen storage, metal hydride hydrogen storage as solid-state storage, chemical hydrogen storage as hydrogen carriers, or underground hydrogen storage, or their combination.

The generated hydrogen gas may be also treated, pre-storage, for example in a hydrogen drying device or a system designed to remove moisture (water vapor) from the hydrogen gas. Drying assists with prevention or corrosion and contamination in pipelines, fuel cells, and reactors. Drying also ensures high purity for industrial applications of the hydrogen gas and prevents ice formation in cryogenic storage. Various drying devices may be implemented such as desiccant dryers, membrane dryers, refrigeration dryers, pressure-based dryers, or electrochemical dryers.

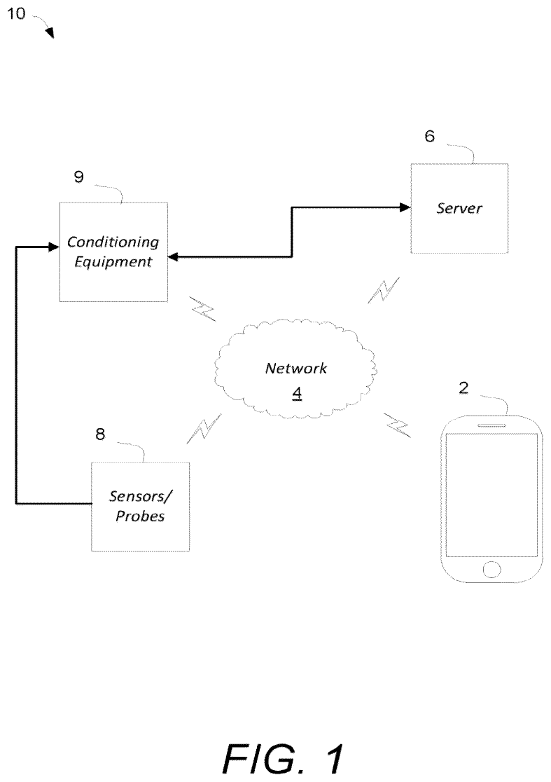

Referring now to the drawings, wherein the depictions are for the purpose of illustrating certain exemplary embodiments only and not for the purpose of limiting the same, FIG. 1 schematically shows an exemplary hydrogen production system 10 that may help implement the methodologies of the present disclosure. The system 10 includes a server system 6, a network 4, and a mobile device 2. In various embodiments, one or more types of concentrating and/or conditioning equipment 9 may be communicatively connected to the system 10. In various embodiments, the system 10 is not adapted for communication with the mobile device 2. In various embodiments, the various components may be directly communicatively connected and/or connected through the network 4. The various components may be physically connected to the network 4 during selected periods of operation without departing from the teachings herein.

Components of the system 10 are shown in FIG. 1 as single elements. Such illustration is for ease of description and it should be recognized that the system 10 may include multiple additional devices, sensors, probes, conditioning equipment, etc. It is to be understood that the system 10 may include a number of other devices, components, modules, and the like. It is to be understood and appreciated that, the various systems may include additional devices, components, modules, and so on, and/or may not include all of the devices, components, modules and so on, discussed in connection with the figures. A combination of these approaches may also be used.

The network 4 may be any suitable series of points or nodes interconnected by communication paths. The network 4 may be interconnected with other networks and contain sub networks network such as, for example, a publicly accessible distributed network like the Internet or other telecommunications networks (e.g., cellular network, intranets, virtual nets, overlay networks and the like). The network 4 may facilitates the exchange of data between and among the mobile device 2, the server system 6, the conditioning equipment 9, and/or one or more sensors or probes. In various embodiments the conditioning equipment 9 and sensors/probes 8 can be directly connected to the server 6.

The server system 6 may be a computer including high-speed microcomputers, minicomputers, mainframes, and/or data storage devices. The server system 6 preferably executes database functions including storing and maintaining a database and processes requests from a user, administrator or from a user or administrator via the mobile device 2 to extract data from, or update, a database as described herein below. The server 6 may additionally provide processing functions for the mobile device 2 as will become apparent to those skilled in the art upon a careful reading of the teachings herein.

In addition, the mobile device 2 may include one or more applications that the user may operate. Operation may include downloading, installing, turning on, unlocking, activating, or otherwise using an application. The application may comprise at least one of an algorithm, software, computer code, and/or the like, for example, mobile application software. In the alternative, the application may be a website accessible through the world wide web.

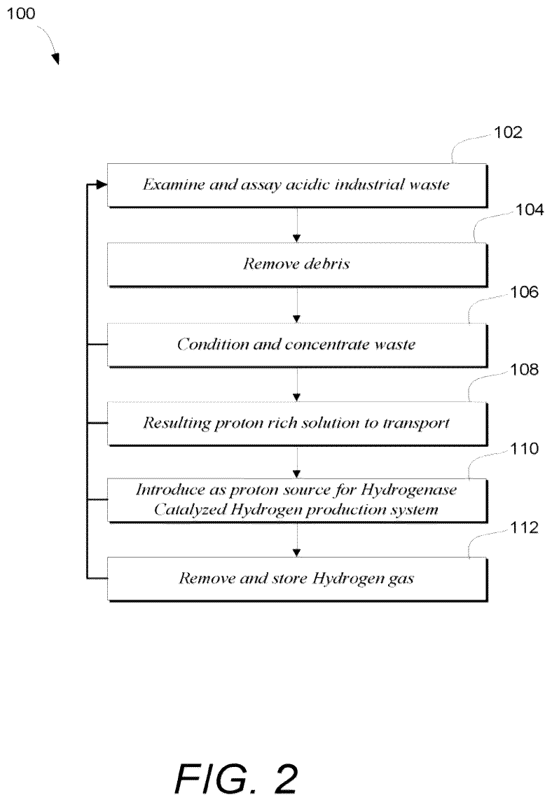

FIG. 2 shows an exemplary process 100 for using industrial waste for the production of hydrogen gas. The process 100 may be executed by the server 6. The process 100 begins at step 102, where an industrial waste site is examined for preferential conditions. The preferential conditions may include one or more criteria including, e.g.: (1) a predefined pH level as effected by economics; (2) a predefined water concentration; (3) radiation below a threshold, any compounds which are not removable by technologies or methods suggested herein and which have been shown to reduce or eliminate the ability of hydrogenase to act as a catalysis for forming H₂ from protons and electrons.

A method of generating hydrogen is disclosed herein. The method may include locating, adjusting, utilizing (A) a source of protons for hydrogen production, utilizing a first apparatus (B) as a mechanism for producing hydrogen ions from the source of protons, locating (C) a source of electrons and generating electrons, and utilizing (D), a mechanism for producing hydrogen gas by combining the hydrogen ions and electrons in a second apparatus. The method may include utilizing one or more apparati, systems, or mechanisms disclosed herein.

The method may include identifying, evaluating, testing, adjusting, monitoring the acidic industrial waste disclosed herein. The method may include lowering a concentration of one or more contaminants or components of the acidic industrial waste, to a lower value than the original value. The lower value may include 0 mg/L such that the contaminant or component is almost entirely or completely removed from the acidic industrial waste. The method may include increasing pH of the acidic industrial waste. The method may include concentrating, conditioning, adjusting, maintaining concentration of the H⁺ ions in the acidic industrial waste to generate a proton-rich solution having a concentration disclosed herein. The method may include assessing, adjusting, maintaining, or changing one or more characteristics of the acidic industrial waste.

The method may include enriching or sorbing additional components into the acidic industrial waste. The method may include dividing the acidic industrial waste into one or more streams, adjusting the individual streams in a different way.

The method may include extracting one or more metal or elemental materials. The method may include utilizing the one or more extracted metals as a source of protons. The methos may include utilizing the one or more extracted metals in the hydrogen production process as a catalyst.

The method may include generating electrons or supplying electrons from one or more sources of electrons disclosed herein. The method may include providing a renewable supply of electrons. The method may include supplying metals from another source than the acidic industrial waste as a source of electrons.

The method may include producing hydrogen gas by reacting the proton-rich solution having the H⁺ concentration disclosed herein. The producing may include one or more reactions such as the hydrogen evolution reaction (HER), chemical HER such as in reactions of metals with acids, electrochemical HER such as in electrolysis of acidic solutions, redox reaction, electrolysis, reactions involving acids and metals, or other reactions originating in the systems and apparati disclosed herein.

The method may include repeatedly supplying the proton-rich solution from one or more streams. The method may include repeatedly supplying electrons to combine with the proton-rich solution H⁺ ions to generate hydrogen gas. The method may include utilizing the acidic industrial waste as a source of the H⁺ ions and electrons, after the source of electrons, such as metal, are extracted from the acidic industrial waste.

### EXAMPLES

### Example 1

A site historically mined for iron, silver, gold, copper, and zinc with long-term AMD was assessed as a source of protons for hydrogen production. The AMD had pH of negative 2 to positive 1. The AMD included heavy metals such as Zn, Cu, and Cd in concentrations of up to 300 mg/L and sulfates in concentration up to 1500 mg/L.

The AMD was collected, conditioned, concentrated, and pH adjusted to about 3 to form a proton-rich solution having a concentration of hydrogen ions of 1.0×10⁻³ M or 1 mM. The AMD was treated to remove the metals using Donnan-based separation. Subsequently, the proton-rich solution was transported from the site to an electrolysis cell site. The electrolysis cell site also included a source of electrons, specifically a DC power supply. The hydrogen ions from the proton-rich solution were combined with the electrons to form hydrogen gas.

### Example 2

A site with acid rock drainage was assessed as a source of protons for hydrogen production. The acid rock drainage had concentrations of lead, sulfur, cyanide, and zinc fluctuating between 5 and 500 mg/L. pH of the acid rock drainage was about −1 to 3.

The acid rock drainage was collected, conditioned, concentrated, and pH adjusted to about 4 to form a proton-rich solution having a concentration of hydrogen ions of 1.0×10⁻⁴ M or 100 μM. The acid rock drainage was treated to remove the metals, including Zn, using magnetic separation. The proton-rich solution (source of hydrogen ions) and the separated Zn (source of electrons) were combined in a reactor to generate hydrogen gas in a direct metal-acid reaction.

### Example 3

AMD from numerous sources was assessed at a collection site. Measured average concentrations included 35 mg/L Fe, 11.8 mg/L Mn, 70 mg/L Al, and 604 mg/L sulfates. pH of the AMD was 2.5-3.5.

The AMD was collected, conditioned, concentrated, and pH adjusted to about 5.2 to form a proton-rich solution having a concentration of hydrogen ions of 6.31×10⁻⁶ M or 6.31 μM. The AMD proceeded via a membrane filtration system. The AMD was treated to minimize concentration of the metals using electrowinning. The proton-rich solution had about 0 mg/L of Fe, Mn, and Al. The proton-rich solution was utilized in an on-site acid amphoteric water electrolysis system (source of hydrogen ions) together with the removed Al which dissolved in the proton-rich solution to release additional hydrogen.

### Example 4

An AMD from a copper and pyrite mining site was assessed for content of metals and sulfates. The AMD included about, on average, 150 mg/L Fe, 105 mg/L Al, 15 mg/L Cu, 86.7 mg/L Zn, 5 mg/L Pb, 3200 mg/L sulfates. pH of the AMD was measured at 3.63.

The AMD was collected, conditioned, concentrated, and pH adjusted to about 3.8 to form a proton-rich solution having a concentration of hydrogen ions of 1.58×10⁻⁴ M or 158.5 μM. The AMD was treated to minimize concentration of the metals using reverse osmosis. The concentration of metals was minimized to less than 2 mg/L. The proton-rich solution was transported off the site to a hydrogen production site utilizing acid amphoteric water electrolysis. The proton-rich solution was used as the acidic electrolyte and the removed Al and Zn were used in the electrolysis process to enhance electron transfer and hydrogen production.

The schematic flow chart diagrams included herein are generally set forth as logical flow chart diagrams. As such, the depicted order and labeled steps are indicative of one embodiment of the presented process. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the process. For example, an arrow may indicate a waiting or monitoring period of unspecified duration between enumerated steps of the depicted process. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Additionally, the order in which a particular method occurs may or may not strictly adhere to the order of the corresponding steps shown. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures. For example, steps 102, 104, 106 and 110 may be executed concurrently in some embodiments.

Additionally, examples in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing.

As will be appreciated by one skilled in the art, aspects of the present disclosure may be embodied as a system, method, and/or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having program code embodied thereon.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

The computer readable program code may be stored and/or propagated on in one or more computer readable medium(s). The computer readable medium may be a tangible computer readable storage medium storing the computer readable program code, such storing is known in the art. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The computer readable program code may execute entirely on the server 6, partly on the server 6, partly on the mobile device 2 and partly on the server 6 or entirely on the mobile device 2.

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A hydrogen gas production system comprising:
a first apparatus configured to produce a proton-rich solution having a concentration of hydrogen ions in a range of about 100 nM to 0.1 M from an acidic industrial waste;
a source of electrons generating electrons; and
a second apparatus configured to produce hydrogen gas by combining the electrons and the hydrogen ions.

2. The system of claim 1, further comprising an acidic industrial waste source for the acidic industrial waste, and wherein the acidic industrial waste includes acidic mine drainage (AMD).

3. The system of claim 1, wherein the acidic industrial waste has a concentration of H⁺ exceeding 1 mol/L.

4. The system of claim 1, wherein the first apparatus includes Donnan-based separation.

5. The system of claim 1, wherein the source of electrons includes a power source.

6. The system of claim 1, wherein the second apparatus includes electrolysis.

7. A hydrogen gas production system comprising:
a source of an acidic industrial waste including one or more metals;
a first apparatus configured to remove the one or more metals from the acidic industrial waste and to concentrate the acidic industrial waste to an acidic proton-rich solution; and
a second apparatus configured to produce hydrogen gas by reacting hydrogen ions present in the acidic proton-rich solution with the one or more metals.

8. The system of claim 7, wherein the one or more metals include Zn.

9. The system of claim 7, wherein the acidic industrial waste includes acidic mine drainage (AMD).

10. The system of claim 7, wherein the acidic proton-rich solution has a concentration of H⁺ of about 100 nM to 0.1 M.

11. The system of claim 7, wherein the second apparatus includes a metal-acid reactor.

12. The system of claim 7, wherein the first apparatus includes an electrowinning apparatus.

13. The system of claim 7, wherein the one or more metals are a source of electrons for the reaction of the proton-rich solution to produce the hydrogen gas.

14. The system of claim 7, wherein the second apparatus includes an acid amphoteric metal electrolysis reactor.

15. The system of claim 7, wherein the first and second apparatus are in a fluid communication.

16. A method of producing hydrogen gas, the method comprising:
providing a stream of an acidic industrial waste with a pH of about −3 to 7 and one or more contaminants;
lowering a concentration of the contaminants in the acidic industrial waste;
converting the acidic industrial waste into a proton-rich solution having H⁺ concentration of at least 100 nM; and
generating hydrogen gas by combining electrons and the H⁺ in the proton-rich solution in a reactor.

17. The method of claim 16, further comprising extracting one or more metals from the one or more contaminants and using the extracted metals as a source of the electrons.

18. The method of claim 16, wherein the converting includes increasing pH of the acidic industrial waste.

19. The method of claim 16, wherein the generating includes a hydrogen evolution reaction (HER).

20. The method of claim 16, wherein the lowering includes removing one or more metals from the acidic industrial waste.
